(19) United States
(12) Patent Application Publication
(10) Pub. No.: US 2023/0353972 A1
(43) Pub. Date: Nov. 2, 2023

(54) SYSTEM FOR WARNING ABOUT ENTERING A RESTRICTED AREA

(71) Applicant: Pfanner Schutzbekleidung GmbH, Koblach (AT)

(72) Inventor: Anton PFANNER, Hohenems (AT)

(73) Assignee: Pfanner Schutzbekleidung GmbH, Koblach (AT)

(21) Appl. No.: 17/926,984

(22) PCT Filed: Apr. 21, 2021
(86) PCT No.: PCT/EP2021/060379

§ 371 Date: Nov. 21, 2022

(30) Foreign Application Priority Data
May 22, 2020 (DE) 10 2020 113 810.5

(51) Int. Cl. H04W 4/021; G08B 25/01

(52) U.S. Cl. CPC H04W 4/021; G08B 25/016

(57) ABSTRACT

A warning system having at least one mobile notification unit, which optically identifies a boundary of a restricted area. The notification unit has at least one motion sensor, which detects movements of objects in the environment of the notification unit, and wherein the notification unit has at least one signal device, which is suitable for outputting an optical and/or acoustic signal if the motion sensor has detected a movement of an object in the environment of the notification unit, and a central unit, which is suitable for receiving a signal sent via radio from the at least one notification unit and to then output a notification to a user of the central unit.

### CROSS-REFERENCE TO RELATED APPLICATIONS

This application is a national stage under 35 U.S.C. § 371 of PCT patent application PCT/EP2021/060379 filed on 21 Apr. 2021, which is pending and which is hereby incorporated by reference in its entirety for all purposes. PCT/EP2021/060379 claims priority to German patent application 10 2020 113 810.5 filed 22 May 2020, which is hereby incorporated by reference in its entirety for all purposes.

### BACKGROUND OF THE INVENTION

### 1. Field of the Invention

The invention relates to a warning system, in particular for supporting safety during forestry work.

### 2. Discussion of the Related Art

If, for example, tree felling work is carried out in a forest, it will be necessary to amply cordon off the area in which the work takes place. This is to prevent particularly uninvolved persons from being injured by falling branches or even falling trees. However, it cannot always be assumed that all persons respect the cordoning off of the restricted area to be created, so that persons enter danger zones despite cordoning off. It also happens that people overlook the cordoning off and are put at risk for this reason.

Therefore, it would be desirable to offer persons an additional possibility to notice their entry into a restricted area and to further indicate to a responsible person that entry into a restricted area by an unauthorized person is imminent or has already taken place.

### SUMMARY OF THE INVENTION

The object of the invention is to provide a warning system which reliably prevents persons from entering a restricted area and indicates to a responsible person that an unauthorized person may be located in a restricted area.

This object is a warning system comprising at least one mobile notification unit, which optically identifies a boundary of a restricted area, wherein the notification unit has at least one motion sensor which detects movements of objects in the environment of the notification unit, and wherein the notification unit has at least one signal device which is suitable for outputting an optical and/or acoustic signal if the motion sensor has detected a movement of an object in the environment of the notification unit, and
a central unit which is suitable for receiving a signal sent via radio from the at least one notification unit and to then output a notification to a user of the central unit.

The invention relates to a warning system comprising at least one mobile notification unit, which optically identifies a boundary of a restricted area, wherein the notification unit has at least one motion sensor, which detects movements of objects in the environment of the notification unit, and wherein the notification unit has at least one signal device, which is suitable for outputting an optical and/or acoustic signal, if the motion sensor has detected a movement of an object in the environment of the notification unit, and a central unit which is suitable for receiving a signal sent via radio from the at least one notification unit and to then output a notification to a user of the central unit. The mentioned objects primarily are persons or groups of persons. They may, however, also be other objects such as animals, manned or unmanned vehicles as well as manned or unmanned aircrafts. So, in particular, if a person enters a restricted area unintentionally, this person will be warned by means of an optical and/or acoustic signal. There is a high probability that this person will then retreat. In parallel, a signal indicating that an entry into the restricted area has taken place is transferred to a central unit via radio, for example long-wave radio. Similarly, a signal can also be output when the person has left the restricted area. The system may be effective in case of intended entry into the restricted area as well. The acoustic and/or optical signaling can be deterrent such that any intentional attempt to enter the restricted area will be stopped, comparable to the effect of an alarm system on a residential building. If it is further signaled to the central unit that a person has entered the restricted area and the user of the central unit establishes that no subsequent exit from the restricted area takes place, the dangerous forestry work can be suspended temporarily and the person can be searched for and taken to a safe place on this basis. Even if the warning system with its signal device is suitable for outputting an optical and/or acoustic signal, it may sometimes be desirable not to have a signal output, although a movement of an object is detected in the environment of the notification unit. In other words, the user of the warning system might possibly desire that only a signal will be sent to the central unit. In this case, the person approaching the notification unit will not know that he or she has been detected. For example, this may be helpful when arresting criminals. Moreover, in the private domain, it may be undesired to create disturbing optical or acoustic signals in the area of notification units. The notification unit can also be further developed such that signs or banners held by the notification unit are equipped with lighting. For example, they may be illuminated by means of LED borders. These LED borders may be operated permanently or as a flashing light, wherein the mode of operation—permanent or flashing—may depend on whether an object has been detected. The optical signals in the area of the notification unit may be movements of the components of the notification unit as well, for example movements of signs and/or banners.

It is particularly useful that the notification unit is able to detect whether the object is crossing or has crossed the boundary of the restricted area, and that the signal is changeable when the object is crossing or has crossed the boundary of the restricted area. Thus, the person approaching the notification unit can be alerted early by the motion sensor so that no entry into the restricted area occurs at all. In principle, signaling to the central unit is dispensable in this case. As soon as it is established that the person is crossing or has already crossed the boundary of the restricted area, it is inevitable to send a signal to the central unit. Furthermore, by changing the type of the optical and/or acoustic signal, the person can be warned of the fact that now not only a warning is present, but that the person is actually located in the restricted area now and the person's life is in danger.

It is usefully provided that the central unit is couplable to a communication unit disposed within a hearing protection of the user so that the notifications can be output via the hearing protection to the user. The user of the central unit will usually be a forestry worker who works alone, who is superior to several other forestry workers or who is charged with the special task of operating and using the warning system. As, during forestry work, a hearing protection often is worn, whether it is an isolated hearing protection or a hearing protection connected to a safety helmet, it might be difficult to call the attention of the user of the central unit to a signal received by the central unit, namely when it is an acoustic signal. This is remedied by the fact that the hearing protection is equipped with a communication device which can be activated by the central unit. The user can perceive a special signal via the hearing protection using the communication unit or a spoken message as well, such as “Person in restricted area”. The communication of the central unit with the communication device of the hearing protection usefully occurs via wireless communication, preferably via Bluetooth. Bluetooth-enabled hearing protection components are known and available. Even though the present invention is explained mainly using forestry work as an example, it can be used in a large number of other environments as well. For example, it may be desirable to prevent or detect the entry of persons to building sites. It may be useful as well to equip any other protected areas with the warning system, for example in the health system. It is provided in preferred embodiments that the central unit is a cellular phone or is couplable to a cellular phone. Considering the communication of the central unit with a Bluetooth communication device of a hearing protection, the advantages are obvious since cellular phones can readily be used for Bluetooth communication.

It is useful as well that the cellular phone is equipped with an application indicating on a display of the cellular phone that a movement of an object has been detected in the environment of the notification unit. Thus, the application (an app) on the cellular phone displays all events in the restricted area and the events can be saved as well in order to be able to reconstruct at a later point in time what happened in the restricted area at which points in time.

According to another useful embodiment, it is provided that several notification units are provided and that the type of the notifications output at the central unit depends on which notification unit has sent a signal. This offers decisive advantages in particular for large restricted areas. On this basis, the user of the central unit knows from where a person approaches so that he or she can take appropriate measures.

Furthermore, it is useful that the notification unit comprises an identification module which is suitable for detecting at least one property of the object. For example, the property of the object may be an authorization to enter the restricted area. A forestry worker, for example, can be equipped with an RFID chip that is registered by the identification module in the notification unit. In this case, an alarm can be suppressed, since it is to be assumed that the forestry worker identified by means of the RFID chip knows how to move and behave in the restricted area. Even if no alarm occurs, it may, however, be provided nevertheless that a signal is sent to the central unit. The display of a cellular phone will then no longer show “Person in restricted area”, but “Authorized person in restricted area”. In this case, the user of the central unit does not have to take any measures. The identification module can also comprise a device for face detection such that it may be actually detected that it might be an authorized person who enters the restricted area. Conversely, certain persons can also experience a “special treatment”. If a user of the central unit wishes to be alerted of the fact that certain persons enter the restricted area, the face detection features of these persons may result in special messages at the central unit, for example “Forester Meier enters restricted area”. The identification module may also be or comprise a body temperature detection module. Thus, the notification unit may react to persons having a normal body temperature in another way than to persons having a high body temperature. This may be useful for infection control, namely when it should be avoided that infected persons, who often have a high body temperature, enter a restricted area. For persons having a normal body temperature, for example, an output of a message to the central unit can be suppressed. Or a message like “Not infected person enters restricted area” will be output at the central unit. If, however, the person has a high body temperature, a message like “Potentially infected person enters restricted area” can be output at the central unit. For persons having a normal body temperature, an output of optical and/or acoustic signals at the notification unit might be dispensed with. For persons having a high body temperature, however, such a signal output at the notification unit may occur. However, it may also be appropriate not to have signals output at the notification unit in case of potentially infected persons, in particular for reasons of data protection. The identification module of the notification unit can also be suitable to cooperate with an application on a cellular phone or a separate device carried by the person who approaches the notification unit. For example, the application or the device may save whether the person concerned was near to persons known to be infected. On this basis, different reactions may again occur. As for the detection of body temperature, different messages may be output at the central unit. Different or no signals can be output at the notification unit as well, as for the detection of body temperature.

It may be provided that the notification unit comprises a camera. In this way, it can be recorded what happens in the environment of the notification unit. The camera may serve as identification module as well, as optical information gives details on whether a person in the environment of the identification module is authorized to enter the restricted area. Further applications of the camera relate to other problems that exist in restricted areas. Work in the forest or at building sites often take several days, several weeks or several months.

It is, of course, impossible to always remove all tools and machinery from the locations when work has been stopped so that they are left unattended at the places of work. If a notification unit is positioned near the tools and machinery, it can be detected using the camera whether thefts or vandalism occur. Such a camera may—alternatively or additionally—be a thermal imaging camera. With this camera, the system can also work in the dark. Furthermore, a thermal imaging camera offers the advantage that the warning system can then be used in the health system in a particularly useful manner. For example, thinking of the fact that, in connection with epidemics, it is absolutely to be avoided that infected persons are permitted entry into a certain closed off area, a thermal imaging camera can give information on whether a person possibly has a high body temperature or fever. In response to that, special measures can be taken.

In this context, it is particularly useful that the notification unit comprises a GPS receiver. A GPS receiver can be activated exactly when unusual events are recorded via the camera, wherein, in this case, a user may also be informed, for example via their cellular phone, where the unusual and possibly preventable events take place. A GPS system is particularly useful with respect to alerting emergency responders since it facilitates localization considerably in case of accidents or makes it possible in the first place. The GPS system can be a pure satellite system. Ground-based GPS signals can be used as well.

Moreover, the warning system according to the invention is particularly advantageous in that the notification unit comprises a tripod and a tube, wherein the tube is suitable for fixing a notification sign and wherein, within the tube, a flexible notification banner is receivable. In different countries, there are different regulations for cordoning off restricted areas, in particular forestal restricted areas. For example, whereas it is common in Austria to use signs, flexible banners are used in Germany. The warning system according to the invention offers both as a sign is attached or attachable to the tube, while a flexible notification banner is always present within the tube and can be put up for marking the boundary of the restricted area. Depending on the current regulations or amendments of regulations, the warning system according to the invention can be developed further in a flexible manner. It can always be used in a useful way in case persons enter a restricted area and should be warned and/or detected in this connection.

### BRIEF DESCRIPTION OF THE INVENTION

The invention will now be explained with reference to the accompanying drawings by way of examples.

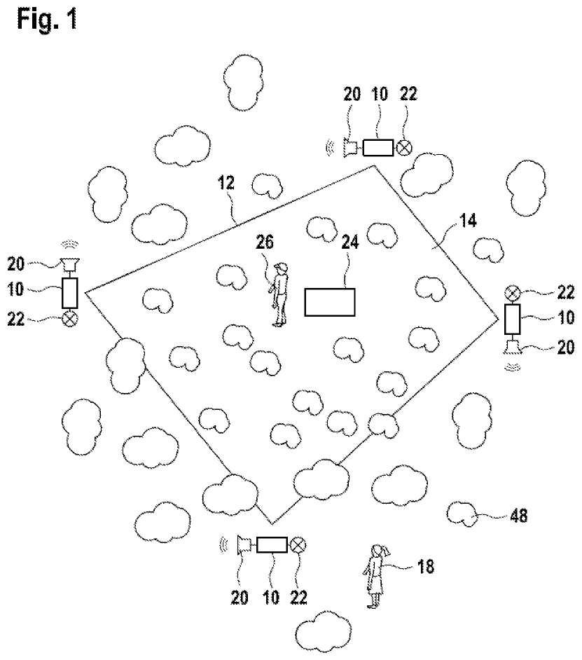

FIG. 1 shows a top view of a forest comprising a restricted area and a warning system according to the invention;

FIG. 2 shows an equipment of a user of the warning system;

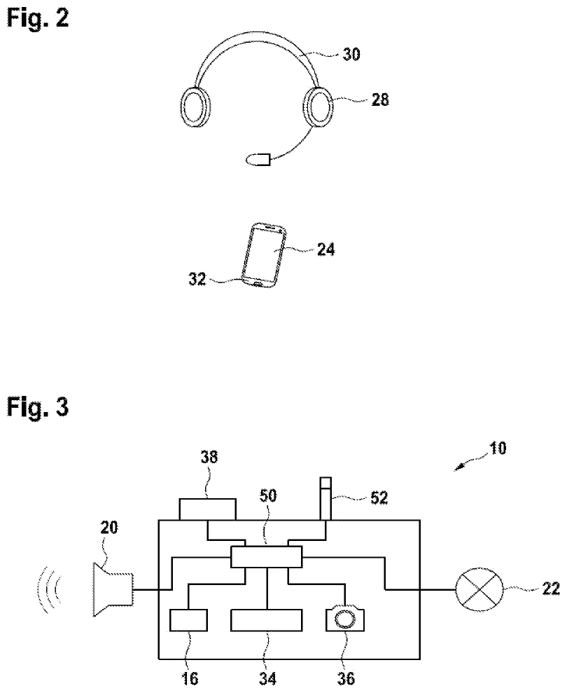

FIG. 3 is a schematic representation of the functional structure of a notification unit;

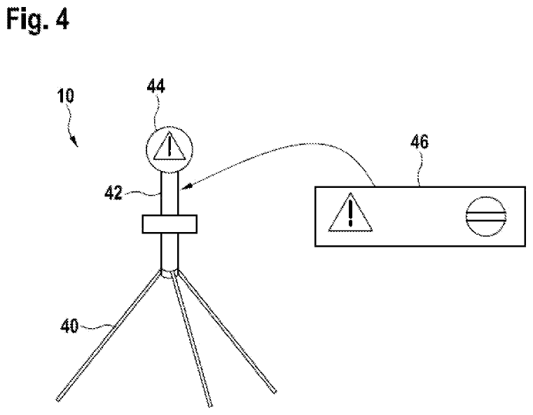

FIG. 4 is a schematic representation of the constructional properties of a notification unit.

### DESCRIPTION OF THE PREFERRED EMBODIMENTS

FIG. 1 shows a top view of a forest comprising a restricted area and a warning system according to the invention. A woodland comprising a large number of trees 48 is shown. A part of this woodland is identified as restricted area 14, the restricted area 14 being surrounded by a boundary 12. At said boundary 12 or near said boundary 12, several notification units 10 are disposed. In the present example, the notification units are located at the corners of the boundary 12. This, however, is not mandatory. It is possible as well that notification units are additionally established at the straight parts of the boundary 12. Furthermore, it is not absolutely required that notification units are disposed at the corners of the restricted area 14. It is important that, for the length of the boundary 12, a sufficient number of notification units 10 is disposed. In the present example, each notification unit 10 has a signal device 20 for the output of an acoustic signal, for example a loudspeaker, and a signal device 22 for the output of an optical signal, for example an LED. It is not necessary that both an acoustic and an optical signal device are provided. The notification units 10 can manage with only one of the stated signal devices as well. Within the restricted area 14, there is the user 26 of a central unit 24 as well as the central unit itself. As soon as an object 18, that is in particular a person, approaches a notification unit 10, said notification unit 10 emits an acoustic and/or optical signal. At the same time, a signal is transferred to the central unit 24, for example within the long-wave range. This is how the user 26 of the central unit 24 is informed of the fact that an object 18 is approaching the restricted area, is crossing or has already crossed the boundary 12 of the restricted area 14. The notification given to the user 26 of the central unit 24 may include information as to whether the object 18 is an object which is authorized or unauthorized to enter the restricted area 14. Furthermore, the user 26 of the central unit 24 can be informed of the fact which of the notification units 10 detected the object 18.

FIG. 2 shows an equipment of a user of the warning system. In this preferred case, the central unit 24 is a commercially available Bluetooth-enabled cellular phone 32. The user 26 of the central unit 24 and of the cellular phone 32, respectively, wears a hearing protection 30 having a communication unit 28. Preferably, this communication unit 28 is Bluetooth-enabled as well. Thus, the cellular phone 32 can supply the user 26 wearing the hearing protection 30 with an acoustic signal or an acoustic message via the response of one of the notification units. At the same time or alternatively, information can be displayed on the display of the cellular phone 32 that state in more detail what is currently happening or what happened at any time.

FIG. 3 is a schematic representation of the functional structure of a notification unit. A notification unit 10 comprising its functional main components is shown. A central control device 50 is coupled to an acoustic signal device 20 and an optical signal device 22. Furthermore, a motion sensor 16 for detection of an object in the environment of the notification unit 10 is connected to the control unit. As another component, the notification unit 10 contains an identification module 34, which is able to distinguish objects by means of their properties, such as for example an object that is permitted to enter the restricted area from an object that is not allowed to enter the restricted area. The notification unit (10) can contain a camera 36 as well which is also connected to the control unit 50. Another component that may be connected to the control unit 50 in connection with the notification unit 10 is a GPS sensor 38. This sensor can be used to determine the position of the notification unit 10 at all times. Moreover, the control unit 50 is in connection with a sender 52. It is via said sender 52, that the notification unit communicates with the central unit. In addition to the sender 52, a receiver can be provided as well such that, for example, the acoustic and/or optical signaling of the notification unit 10 can be stopped or otherwise prevented by the central unit. The receiver is not shown here. Instead of a sender 52 and a receiver, a transceiver can also be provided that assumes both tasks, that is both sending and receiving.

FIG. 4 is a schematic representation of the constructional properties of a notification unit. A tripod 40 supports a tube 42 on which notification signs can be attached, for example the notification sign 44. The notification signs warn persons approaching the notification unit 10 of entering a restricted area. Inside the tube 42, a banner 46 can be stored which can be put up by means of the notification unit 10 as well. Thus, an even more extensive notification of a restricted area can be provided.

The features of the invention disclosed in the preceding description, in the figures as well as in the claims can be essential for the implementation of the invention both individually and in any combination.

### LIST OF REFERENCE NUMERALS

10 notification unit
12 boundary
14 restricted area
16 motion sensor
18 objects
20 optical signal device
22 acoustic signal device
24 central unit
26 user
28 communication unit
30 hearing protection
32 cellular phone
34 identification module
36 camera
38 GPS receiver
40 tripod
42 tube
44 notification sign
46 notification banner

1. A warning system comprising:
at least one mobile notification unit, which optically identifies a boundary of a restricted area, wherein the notification unit has at least one motion sensor which detects movements of objects in the environment of the notification unit, and wherein the notification unit has at least one signal device which is suitable for outputting an optical or acoustic signal if the motion sensor has detected a movement of an object in the environment of the notification unit; and
a central unit which is suitable for receiving a signal sent via radio from the at least one notification unit and to then output a notification to a user of the central unit.

2. The warning system according to claim 1, wherein the notification unit is able to detect whether the object is crossing or has crossed the boundary of the restricted area, and that the signal is changeable when the object is crossing or has crossed the boundary of the restricted area.

3. The warning system according to claim 1, wherein the central unit is couplable to a communication unit disposed within a hearing protection of the user so that the notifications can be output via the hearing protection to the user.

4. The warning system according to claim 1, wherein the central unit is a cellular phone or is couplable to a cellular phone.

5. The warning system according to claim 4, wherein the cellular phone is equipped with an application indicating on a display of the cellular phone that a movement of an object has been detected in the environment of the notification unit.

6. The warning system according to claim 1, wherein several notification units are provided and that the type of the notifications output at the central unit depends on which notification unit has sent a signal.

7. The warning system according to claim 1, wherein the notification unit comprises an identification module which is suitable for detecting at least one property of the object.

8. The warning system according to claim 1, wherein the notification unit comprises a camera.

9. The warning system according to claim 1, wherein the notification unit comprises a GPS receiver.

10. The warning system according to claim 1, wherein the notification unit comprises a tripod and a tube, wherein the tube is suitable for fixing a notification sign and wherein, within the tube, a flexible notification banner is receivable.
